(19) United States
(12) Patent Application Publication
(10) Pub. No.: US 2016/0029576 A1
(43) Pub. Date: Feb. 4, 2016

(54) TREE TRIMMING APPARATUS

(71) Applicant: Meng-Chyang PENG, Taipei City (TW)

(72) Inventor: Meng-Chyang PENG, Taipei City (TW)

(21) Appl. No.: 14/446,856

(22) Filed: Jul. 30, 2014

(51) Int. Cl. A01G 23/095; B27L 11/00; A01G 3/00

(52) U.S. Cl. CPC A01G 23/095; A01G 3/002; B27L 11/00

(57) ABSTRACT

A tree trimming apparatus includes a movable carrier, a shredder device, a transmission hose, and a support stand. The movable carrier has a container. The shredder device includes a housing, a plurality of cutters, and a motor. The housing has a through hole. The cutters are rotatably positioned in the housing. The motor is located on the housing and is connected to the cutters. The transmission hose has a first end portion and a second end portion. The first end portion is connected to the through hole, and the second end portion is aligned with the container. The support stand is connected between the movable carrier and the shredder device. When the cutters contact a branch, the branch is cut and enters the housing, and falls into the container through the through hole and the transmission hose.

### BACKGROUND

1. Field of Invention

The present disclosure relates to a tree trimming apparatus. More particularly, the present disclosure relates to a movable tree trimming apparatus.

2. Description of Related Art

As trees grow, their branches become increasingly longer and their leaves increasingly plentiful. If trees are planted at roadsides and are not cut for a long time, a large number of leaves fall on roads, thus causing inconvenience to cleaners. In serious situations, fallen leaves may affect driving safety.

A conventional tree trimming tool may be a cutter, a saw, or an electric saw for cutting trees. When a tree at a roadside must be cut, a worker needs to place a ladder against the tree. Thereafter, the worker can climb up the ladder to reach the branches of the tree. The worker can then use a cutter, saw, or electric saw to cut too long branches. Such a way of cutting trees, however, is not only dangerous for the worker, but also the worker needs to have good physical strength to be qualified to do the job. When a lot of trees are required to be cut, the labor costs and time for cutting the trees are increased.

Moreover, cut branches often fall on roads. When workers complete the cutting job, they need to load the cut branches onto trucks, such that the cut branches do not obstruct the roads. That is to say, the workers using the aforesaid tree trimming tools to cut trees not only need to cut the trees, but also need to clean road surfaces covered by the branches. As a result, the workers are significantly burdened and also require a significant amount of time to complete a tree trimming project.

### SUMMARY

An aspect of the present invention is to provide a tree trimming apparatus.

According to an embodiment of the present invention, a tree trimming apparatus includes a movable carrier, a shredder device, a transmission hose, and a support stand. The movable carrier has a container. The shredder device includes a housing, a plurality of cutters, and a motor. The housing has a through hole and an opening. The cutters are rotatably positioned in the housing for cutting a branch that is in the opening of the housing. The motor is located on the housing and is connected to the cutters for driving the cutters to rotate. The transmission hose has a first end portion and a second end portion. The first end portion is connected to the through hole, and the second end portion is aligned with the container. The support stand is connected between the movable carrier and the shredder device. The support stand includes a plurality of extending arms and expandable devices. The extending arms are connected between the movable carrier and the shredder device, and are pivoted with each other. The expandable devices are respectively located on the extending arms for adjusting a position of the shredder device, such that the shredder device is located in the container or contacts the branch. When the cutters contact the branch, the branch is cut and enters the housing, and falls into the container through the through hole and the transmission hose.

In an embodiment of the present invention, the support stand further includes a horizontal rotating device. The horizontal rotating device is disposed on the movable carrier for adjusting the position of the shredder device.

In an embodiment of the present invention, the tree trimming apparatus further includes a displacement controller. The displacement controller is electrically coupled to the expandable devices and the horizontal rotating device for controlling the position of the shredder device.

In an embodiment of the present invention, the shredder device further includes a rotating disk. The rotating disk is connected to the motor. The cutters are located on the rotating disk.

In an embodiment of the present invention, the tree trimming apparatus further includes a motor controller. The motor controller is electrically coupled to the motor for switching on or switching off the motor.

In an embodiment of the present invention, the tree trimming apparatus further includes a camera and a display screen. The camera is disposed on the housing for receiving an image. The display screen is located on the movable carrier and is electrically coupled to the camera for displaying the image.

In an embodiment of the present invention, the tree trimming apparatus further includes a camera controller. The camera controller is electrically coupled to the camera for controlling a camera angle of the camera.

In an embodiment of the present invention, the movable carrier includes a freight vehicle or a truck.

In an embodiment of the present invention, each of the expandable devices includes an oil pressure cylinder or an air pressure cylinder.

In the aforementioned embodiments of the present invention, the cutters of the shredder device are driven by the motor, and the expandable devices of the support stand can adjust the position of the shredder device. When the shredder device is moved by the support stand to the branch that is required to be cut, the branch contacting the cutters are cut to enter the housing. Moreover, since the housing has the through hole, the first end portion of the transmission hose is connected to the through hole, and the second end portion of the transmission hose is aligned with the container, the cut branch in the housing can fall into the container through the through hole and the transmission hose.

Hence, the tree trimming apparatus can be used to cut the branch without the use of manpower. The movable carrier (e.g., a truck) only needs to be driven to a location adjacent to the tree, and the cutters of the shredder device can contact the branch by the expandable devices of the support stand. As a result, users do not need to dangerously climb the tree to cut the branch. Moreover, the cut branch that is cut by the shredder device falls into the container of the movable carrier through the through hole and the transmission hose by gravity, and the cut branch does not fall on the road. Therefore, labor costs and time can be significantly reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a side view of a tree trimming apparatus according to an embodiment of the present invention, shown in a state when operating;

FIG. 2 is a front view of a shredder device shown in FIG. 1, in which the front view is from a direction D2;

FIG. 3 is a block diagram of a displacement controller electrically coupled to an expandable device shown in FIG. 1;

FIG. 4 is a block diagram of a motor controller electrically coupled to a motor shown in FIG. 1; and

FIG. 5 is a block diagram of a camera controller electrically coupled to a camera shown in FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

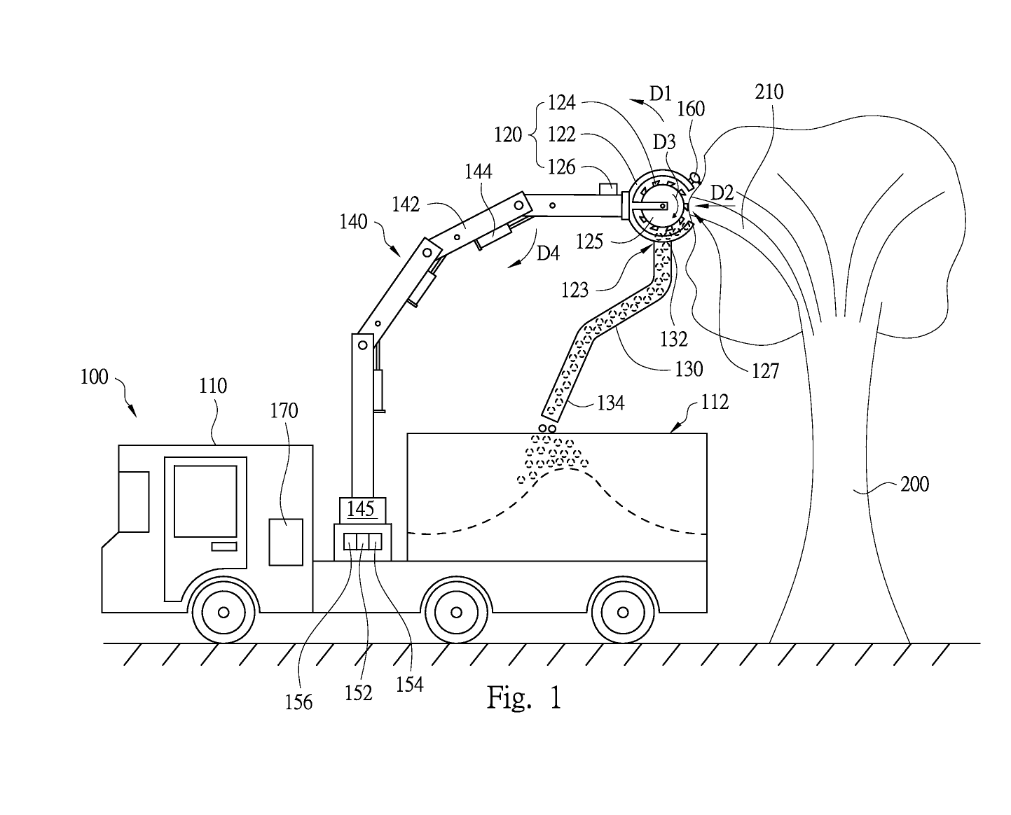

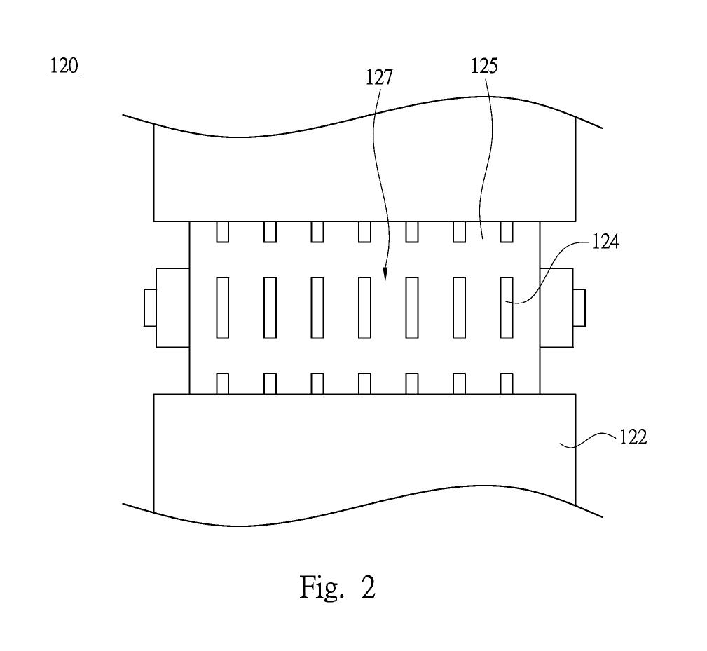

FIG. 1 is a side view of a tree trimming apparatus 100 according to an embodiment of the present invention, shown in a state when operating. FIG. 2 is a front view of a shredder device 120 shown in FIG. 1, in which the front view is from a direction D2. As shown in FIG. 1 and FIG. 2, the tree trimming apparatus 100 includes a movable carrier 110, the shredder device 120, a transmission hose 130, and a support stand 140. The movable carrier 110 has a container 112, and may be a freight vehicle or a truck.

The shredder device 120 includes a housing 122, a plurality of cutters 124, and a motor 126. The housing 122 has a through hole 123 and an opening 127. The cutters 124 are rotatably positioned in the housing 122 for cutting a branch that is in the opening 127 of the housing 122. The motor 126 is located on the housing 122 and is connected to the cutters 124 for driving the cutters 124 to rotate. The transmission hose 130 has a first end portion 132 and a second end portion 134. The first end portion 132 is connected to the through hole 123, and the second end portion 134 is aligned with the container 112.

The support stand 140 is connected between the movable carrier 110 and the shredder device 120, and includes a plurality of extending arms 142, a plurality of expandable devices 144, and a horizontal rotating device 145. The extending arms 142 are connected between the movable carrier 110 and the shredder device 120, and are pivoted with each other. The expandable devices 144 are respectively located on the extending arms 142 for adjusting the position of the shredder device 120, such that the shredder device 120 can be located in the container 112 or contacts a branch. Each of the expandable devices 144 may include an oil pressure cylinder or an air pressure cylinder. The horizontal rotating device 145 is disposed on the movable carrier 110 for adjusting the position of the shredder device 120.

Moreover, the shredder device 120 may further include a rotating disk 125. The rotating disk 125 is connected to the motor 126, and the cutters 124 are located on the rotating disk 125. When the motor 126 is switched on, the rotating disk 125 connected to the motor 126 rotates, such that the cutters 124 on the rotating disk 125 synchronously rotate with the rotating disk 125.

The tree trimming apparatus 100 may further include a displacement controller 152 and a motor controller 154. The displacement controller 152 is electrically coupled to the expandable devices 144 and the horizontal rotating device 145 for controlling the position of the shredder device 120. The motor controller 154 is electrically coupled to the motor 126 for switching on or switching off the motor 126. That is to say, the displacement controller 152 and the motor controller 154 can control the shredder device 120.

In this embodiment, the tree trimming apparatus 100 may further include a camera 160, a display screen 170, and a camera controller 156. The camera 160 is disposed on the housing 122 for receiving an image. The display screen 170 is located on the movable carrier 110 and is electrically coupled to the camera 160 for displaying the image. The camera controller 156 is electrically coupled to the camera 160 for controlling the camera angle of the camera 160.

In use, the movable carrier 110 (e.g., a truck) can be driven to a location adjacent to a tree 200, after which the expandable devices 144 and the horizontal rotating device 145 of the support stand 140 can be adjusted by operating the displacement controller 152, such that the shredder device 120 can move in a direction D1, and the cutters 124 of the shredder device 120 can be adjacent to a branch 210. Thereafter, the motor 126 can be switched on by the motor controller 154, such that the cutters 124 rotate with the rotating disk 125. In this embodiment, the rotating disk 125 is driven to rotate in a direction D3 by the motor 126. When the cutters 124 contact the branch 210 through the opening 127 of the housing 122, the branch 210 can be cut by the cutters 124.

Furthermore, when the extending arms 142 of the support stand 140 move the shredder device 120 to the branch 210 that is required to be cut, the branch 210 is cut and enters the housing 122. Since the housing 122 has the through hole 123, the first end portion 132 of the transmission hose 130 is connected to the through hole 123, and the second end portion 134 of the transmission hose 130 is aligned with the container 112, the cut branch 210 in the housing 122 can fall into the container 112 through the through hole 123 and the transmission hose 130.

In addition, users can see the image received by the camera 160 from the display screen 170, and the camera angle of the camera 160 can be controlled by the camera controller 156. Therefore, a real-time cutting image can be shown on the display screen 170, and users can accurately adjust the position of the shredder device 120.

After cutting the tree 200, the shredder device 120 can be moved to the movable carrier 110 in a direction D4 by the extending arms 142 of the support stand 140. Thereafter, the movable carrier 110 can be driven to another location having a tree that is required to be cut, and the aforementioned cutting processes can be repeated.

The tree trimming apparatus 100 can be used to cut the branch 210 without the use of manpower. The movable carrier 110 (e.g., a truck) only needs to be driven to a location adjacent to the tree 200, and the cutters 124 of the shredder device 120 can contact the branch 210 by the expandable devices 144 of the support stand 140. As a result, users do not need to dangerously climb the tree 200 to cut the branch 210. Moreover, the cut branch 210 that is cut by the shredder device 120 falls into the container 112 of the movable carrier 110 through the through hole 123 and the transmission hose 130 by gravity, and the cut branch 210 does not fall on the road. Therefore, labor costs and time can be significantly reduced.

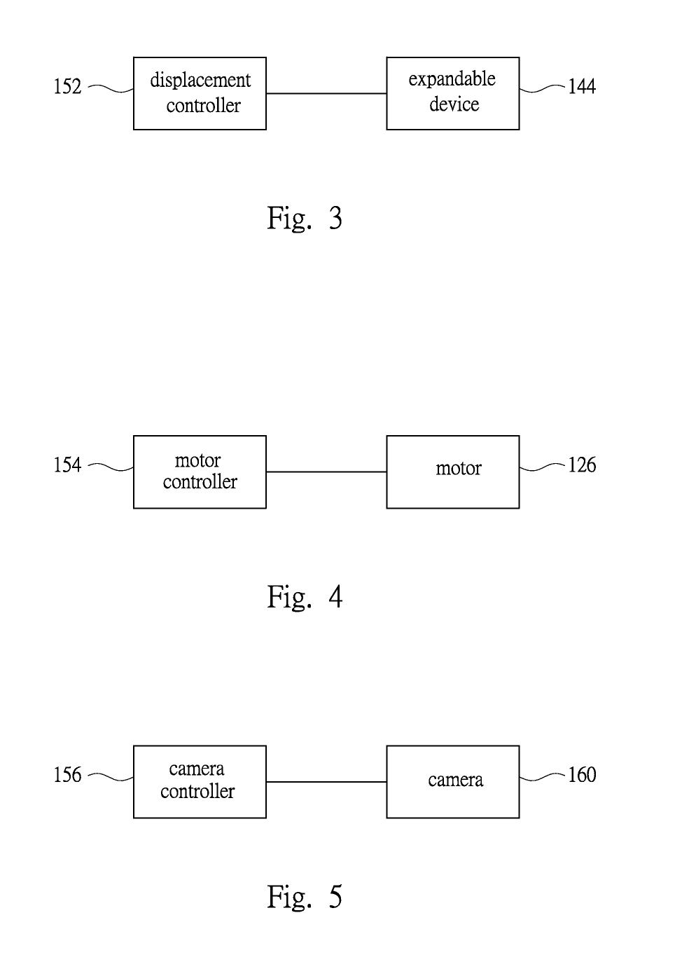

FIG. 3 is a block diagram of the displacement controller 152 electrically coupled to one of the expandable devices 144 shown in FIG. 1. As shown in FIG. 3, the displacement controller 152 is electrically coupled to the expandable device 144. Therefore, users can control the position of the shredder device 120 by the displacement controller 152.

FIG. 4 is a block diagram of the motor controller 154 electrically coupled to the motor 126 shown in FIG. 1. As shown in FIG. 4, the motor controller 154 is electrically coupled to the motor 126. Therefore, users can switch on or switch off the motor 126 by the motor controller 154.

FIG. 5 is a block diagram of the camera controller 156 electrically coupled to the camera 160 shown in FIG. 1. As shown in FIG. 5, the camera controller 156 is electrically coupled to the camera 160. Therefore, users can control the camera angle of the camera 160 by the camera controller 156.

Compared with the prior art, the cutters of the shredder device are driven by the motor, and the position of the shredder device can be adjusted by the expandable devices of the support stand. When the rotating cutters contact the branch that is required to be cut, the branch contacting the cutters is cut and enters the housing. The housing has the through hole, the first end portion of the transmission hose is connected to the through hole, and the second end portion of the transmission hose is aligned with the container. As a result, the cut branch in the housing can fall into the container through the through hole and the transmission hose by gravity. The tree trimming apparatus can be used to cut the branch without the use of manpower, so that labor costs and time can be significantly reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A tree trimming apparatus comprising:
a movable carrier having a container;
a shredder device comprising:
a housing having a through hole and an opening;
a plurality of cutters rotatably positioned in the housing for cutting a branch that is in the opening of the housing; and
a motor located on the housing and connected to the cutters for driving the cutters to rotate;
a transmission hose having a first end portion and a second end portion, wherein the first end portion is connected to the through hole, and the second end portion is aligned with the container; and
a support stand connected between the movable carrier and the shredder device, wherein the support stand comprises:
a plurality of extending arms connected between the movable carrier and the shredder device and pivoted with each other; and
a plurality of expandable devices respectively located on the extending arms for adjusting a position of the shredder device, such that the shredder device is located in the container or contacts the branch, wherein when the cutters contact the branch, the branch is cut and enters the housing, and falls into the container through the through hole and the transmission hose.

2. The tree trimming apparatus of claim 1, wherein the support stand further comprises:
a horizontal rotating device disposed on the movable carrier for adjusting the position of the shredder device.

3. The tree trimming apparatus of claim 2, further comprising:
a displacement controller electrically coupled to the expandable devices and the horizontal rotating device for controlling the position of the shredder device.

4. The tree trimming apparatus of claim 1, wherein the shredder device further comprises:
a rotating disk connected to the motor, wherein the cutters are located on the rotating disk.

5. The tree trimming apparatus of claim 1, further comprising:
a motor controller electrically coupled to the motor for switching on or switching off the motor.

6. The tree trimming apparatus of claim 1, further comprising:
a camera disposed on the housing for receiving an image; and
a display screen located on the movable carrier and electrically coupled to the camera for displaying the image.

7. The tree trimming apparatus of claim 6, further comprising:
a camera controller electrically coupled to the camera for controlling a camera angle of the camera.

8. The tree trimming apparatus of claim 1, wherein the movable carrier comprises a freight vehicle or a truck.

9. The tree trimming apparatus of claim 1, wherein each of the expandable devices comprises an oil pressure cylinder or an air pressure cylinder.
